(19) United States
(12) Patent Application Publication
(10) Pub. No.: US 2018/0173659 A1
(43) Pub. Date: Jun. 21, 2018

(54) SYSTEMS AND METHODS FOR SINGLE-WIRE CONTROL OF A SLAVE INTEGRATED CIRCUIT

(71) Applicant: QUALCOMM Incorporated, San Diego, CA (US)

(72) Inventors: Huibert DenBoer, Escondido, CA (US); Ari Huostila, Escondido, CA (US)

(21) Appl. No.: 15/383,447

(22) Filed: Dec. 19, 2016

(51) Int. Cl. G06F 13/364; G06F 13/42; G06F 13/40; G06F 13/12

(52) U.S. Cl. CPC G06F 13/364; G06F 13/124; G06F 13/404; G06F 13/4282

(57) ABSTRACT

An electronic device is described. The electronic device includes a master integrated circuit (IC) that includes a master finite state machine (FSM). The electronic device also includes a slave IC that includes a synchronization module and a slave FSM. The electronic device further includes a control interface coupling the master IC to the slave IC. The control interface is implemented via a single wire. The master FSM communicates its states or state transitions to the synchronization module via the control interface. The synchronization module decodes the master FSM's states or state transitions and uses the decoded states or state transitions to step the slave FSM in real time such that states or state transitions in the slave FSM mirror the states or state transitions in the master FSM.

### TECHNICAL FIELD

The present disclosure relates generally to communications. More specifically, the present disclosure relates to systems and methods for single-wire control of a slave integrated circuit (IC).

### BACKGROUND

Electronic devices (cellular telephones, wireless modems, computers, digital music players, Global Positioning System units, Personal Digital Assistants, gaming devices, etc.) have become a part of everyday life. Small computing devices are now placed in everything from automobiles to housing locks. The complexity of electronic devices has increased dramatically in the last few years. For example, many electronic devices have one or more processors that help control the device, as well as a number of digital circuits to support the processor and other parts of the device.

Multi-chip electronic devices may include a variety of circuits used during operation. For example, a multi-chip electronic device may include multiple integrated circuits (ICs) to perform different operations. A master IC may control one or more slave ICs. Minimizing the number of input and output signals between the ICs may reduce the size and cost of electronic devices. Therefore, benefits may be realized by single-wire control of a slave integrated circuit (IC).

### SUMMARY

An electronic device is described. The electronic device includes a master integrated circuit (IC) that includes a master finite state machine (FSM). The electronic device also includes a slave IC that includes a synchronization module and a slave FSM. The electronic device further includes a control interface coupling the master IC to the slave IC. The control interface is implemented via a single wire. The master FSM communicates its states or state transitions to the synchronization module via the control interface. The synchronization module decodes the master FSM's states or state transitions and uses the decoded states or state transitions to step the slave FSM in real time such that states or state transitions in the slave FSM mirror the states or state transitions in the master FSM.

The master FSM may send its states or state transitions over the control interface in encoded state bits. The master FSM may send an additional bit, in addition to the master FSM's states or state transitions, indicating that other control data will also be sent. The other control data may include at least one of automatic gain control (AGC) data, receive (RX) power control, RX control, transmit (TX) control, TX power control or volume.

The electronic device may also include a separate register programming interface that is implemented by time multiplexing the single wire of the control interface.

The states or state transitions communicated by the master FSM may include a variable series of states or state transitions. The states or state transitions of the master FSM may correspond to equivalent states or state transitions of the slave FSM.

In an approach, the slave IC may communicate a clock signal to the master IC via a clock interface. The master FSM and the synchronization module of the slave IC may synchronize communication of the master FSM's states or state transitions based on the clock signal.

In another approach, the master IC communicates a clock signal to the slave IC via the clock interface. The master FSM and the synchronization module of the slave IC may synchronize communication of the master FSM's states or state transitions based on the clock signal.

In yet another approach, the control interface is implemented as an asynchronous interface with no clock signal. The slave IC may oversample the control interface to determine a falling edge of a start bit of the master FSM.

The master IC may be a digital baseband (BB) IC and the slave IC may be a radio frequency integrated circuit (RFIC).

The electronic device may also include a plurality of slave ICs. The master FSM may communicate its states or state transitions to each of the plurality of slave ICs. The plurality of slave ICs may use the states or state transitions of the master FSM to step their slave FSMs in real time such that states or state transitions in the plurality of slave FSMs mirror the states or state transitions in the master FSM.

A method is also described. The method includes communicating states or state transitions from a master FSM of a master IC to a synchronization module of a slave IC via a control interface coupling the master IC to the slave IC. The control interface is implemented via a single wire. The method also includes decoding, by the synchronization module, the master FSM's states or state transitions. The method further includes stepping a slave FSM of the slave IC in real time based on the decoded states or state transitions such that states or state transitions in the slave FSM mirror the states or state transitions in the master FSM.

An apparatus is also described. The apparatus includes means for communicating states or state transitions from a master FSM of a master IC to a synchronization module of a slave IC via a control interface coupling the master IC to the slave IC. The control interface is implemented via a single wire. The apparatus also includes means for decoding, by the synchronization module, the master FSM's states or state transitions. The apparatus further includes means for stepping a slave FSM of the slave IC in real time based on the decoded states or state transitions such that states or state transitions in the slave FSM mirror the states or state transitions in the master FSM.

A computer-program product is also described. The computer-program product includes a non-transitory computer-readable medium having instructions thereon. The instructions include code for causing an electronic device to communicate states or state transitions from a master FSM of a master IC to a synchronization module of a slave IC via a control interface coupling the master IC to the slave IC. The control interface is implemented via a single wire. The instructions also include code for causing the electronic device to decode, by the synchronization module, the master FSM's states or state transitions. The instructions further include code for causing the electronic device to step a slave FSM of the slave IC in real time based on the decoded states or state transitions such that states or state transitions in the slave FSM mirror the states or state transitions in the master FSM.

### BRIEF DESCRIPTION OF THE DRAWINGS

FIG. 1 is a block diagram illustrating an electronic device configured for single-wire control of a slave integrated circuit (IC) by a master IC;

FIG. 2 is a flow diagram illustrating a method for single-wire control of a slave IC by a master IC;

FIG. 3 is a block diagram illustrating a configuration of a mixed-signal device configured for single-wire control of an analog IC by a digital IC;

FIG. 4 is a block diagram illustrating a configuration of a wireless communication device configured for single-wire control of a radio frequency IC (RFIC) by a digital baseband IC (BB IC);

FIG. 5 illustrates an example of a master and slave finite state machine (FSM) for two encoded state bits where the encoded state bits in this example represent the actual state transitions;

FIG. 6 illustrates an example of a single-wire transaction according to a control protocol described herein;

FIG. 7 illustrates an example of another single-wire transaction according to the control protocol described herein;

FIG. 8 is a flow diagram illustrating another method for single-wire control of a slave IC by a master IC;

FIG. 9 is a flow diagram illustrating yet another method for single-wire control of a slave IC by a master IC; and

FIG. 10 illustrates certain components that may be included within an electronic device.

### DETAILED DESCRIPTION

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

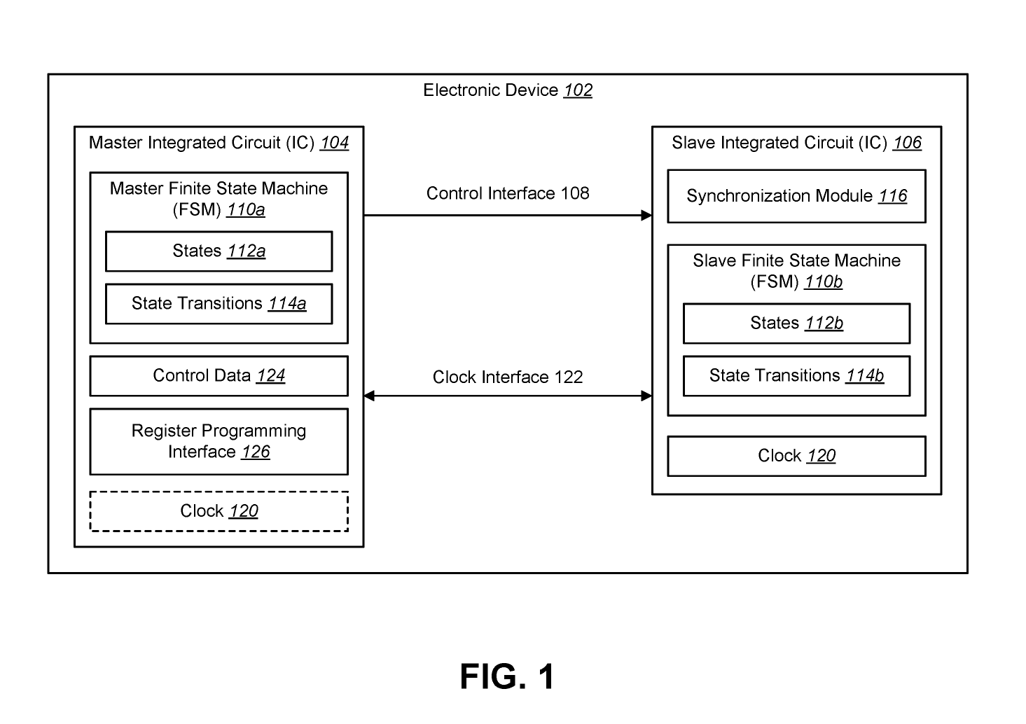

FIG. 1 is a block diagram illustrating an electronic device 102 configured for single-wire control of a slave integrated circuit (IC) 106 by a master IC 104. The electronic device 102 may include separate ICs that perform different operations in the electronic device 102.

The electronic device 102 is a multi-chip system. In a multi-chip system, the electronic device 102 includes multiple separate integrated circuits (ICs). In a configuration, the multi-chip electronic device 102 may be an all-digital system that uses multiple digital IC s.

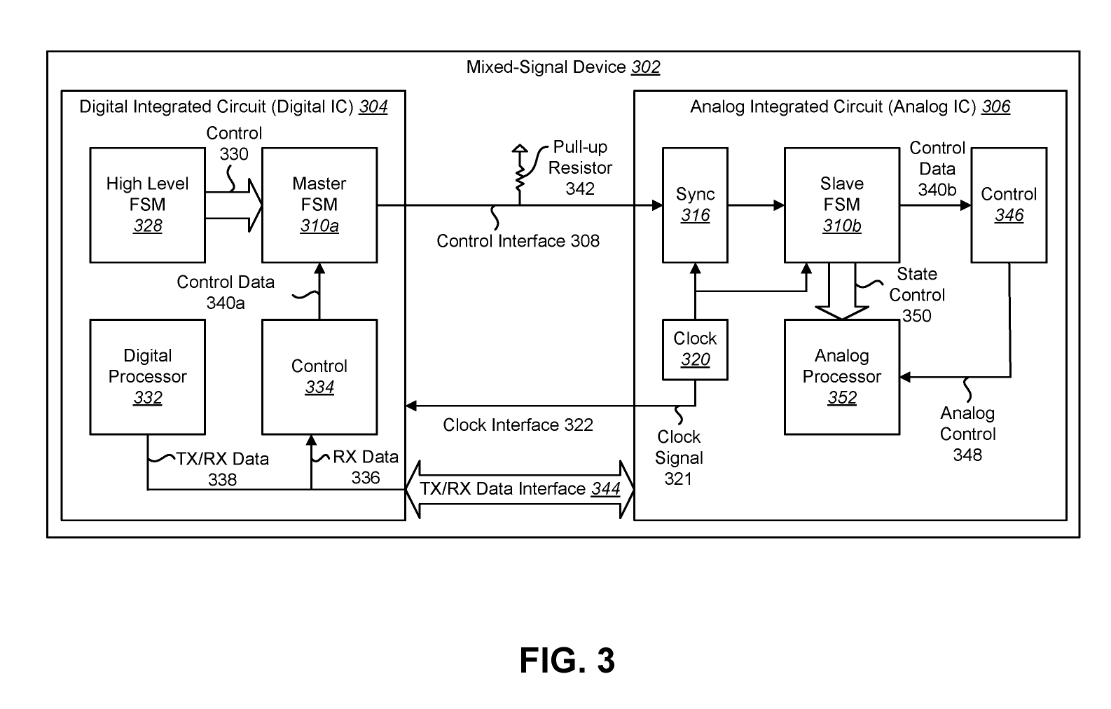

In another configuration, the multi-chip electronic device 102 may be a mixed-signal system. A mixed-signal system may use one or more digital baseband ICs and one or more analog ICs. Examples of mixed-signal systems include terrestrial networks, audio devices and wireless communication systems. An example of a mixed-signal device is described in connection with FIG. 3.

A terrestrial network is a type communication network in which a signal is broadcast by radio frequency (RF) waves from a terrestrial (e.g., Earth based) transmitter to a receiver. An example of a terrestrial network is television broadcasting in which an RF television signal is transmitted to the TV receiver from a television station, and received with an antenna. In this case, the TV receiver may be a multi-chip, mixed-signal device. Another example of a terrestrial network is digital radio broadcasting. A terrestrial network device may include one or more analog ICs to receive and/or transmit RF signals and one or more digital ICs to process digital information.

Another example of a mixed-signal system is an audio device. An audio device may include one or more analog ICs and one or more digital ICs to process digital information. The audio device may be a wireless or non-wireless device. Examples of mixed-signal audio devices include portable digital audio players, MP3 players, headsets, headphones, digital audio receivers (e.g., an automobile digital radio receiver), wireless speakers (e.g., WiFi or Bluetooth speakers), smart speakers, wireless audio adapters (e.g., Bluetooth audio adapter), etc.

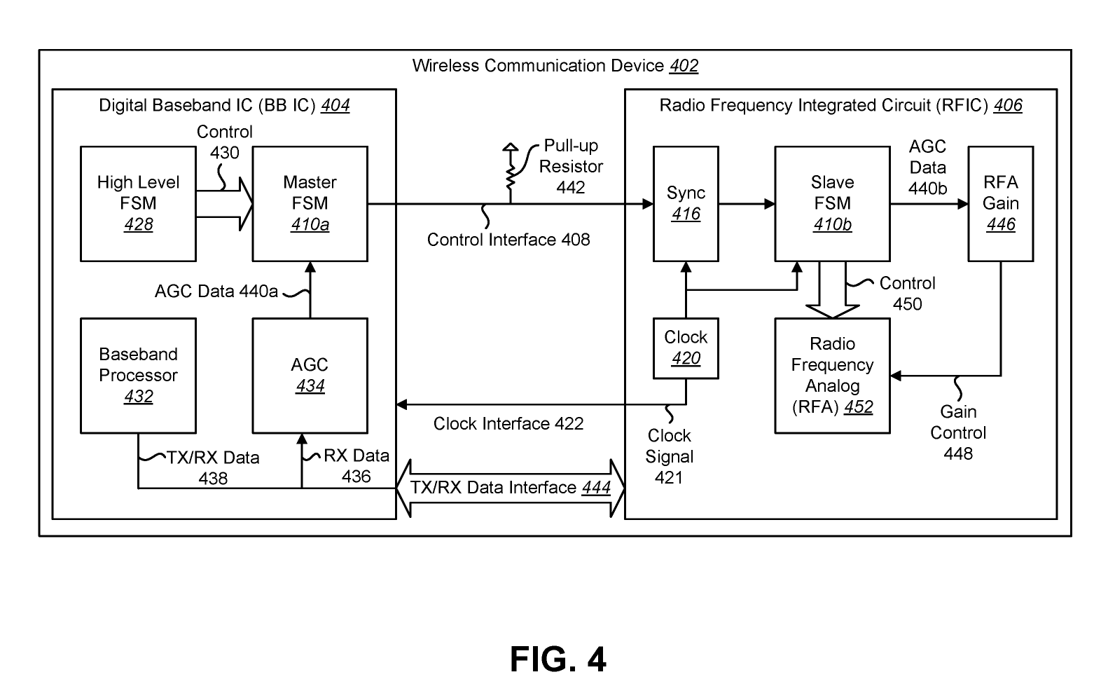

Yet another example of a mixed-signal system is a wireless communication system. Wireless communication systems are widely deployed to provide various types of communication content such as voice, video, data and so on. These systems may be multiple-access systems capable of supporting simultaneous communication of multiple wireless communication devices with one or more base stations. A wireless communication device may include one or more digital baseband ICs and one or more analog radio frequency ICs (RFICs). An example of a wireless communication device is described in connection with FIG. 4.

A master IC 104 may be used in conjunction with one or more slave ICs 106. For example, a digital IC (e.g., baseband IC) may be a master IC 104 and an analog IC (e.g., RFIC) may be a slave IC 106. In another example, both the master IC 104 and the slave IC 106 may be digital ICs.

When separate ICs are used, it is desirable to minimize the number input/output (IO) connections between them in order to reduce cost. For example, in the case of a mixed-signal system, the IO count is dominated by the width of analog-to-digital converter (ADC) data passed between the ICs, but it is still necessary to allow the master IC 104 to maintain control of the slave IC 106 during operation. Examples of operations that may be controlled by the master IC 104 include communication protocols, power management, startup, shutdown, data transfer, etc. Benefits may be realized by minimizing the number of IO connections allocated to control the slave IC 106.

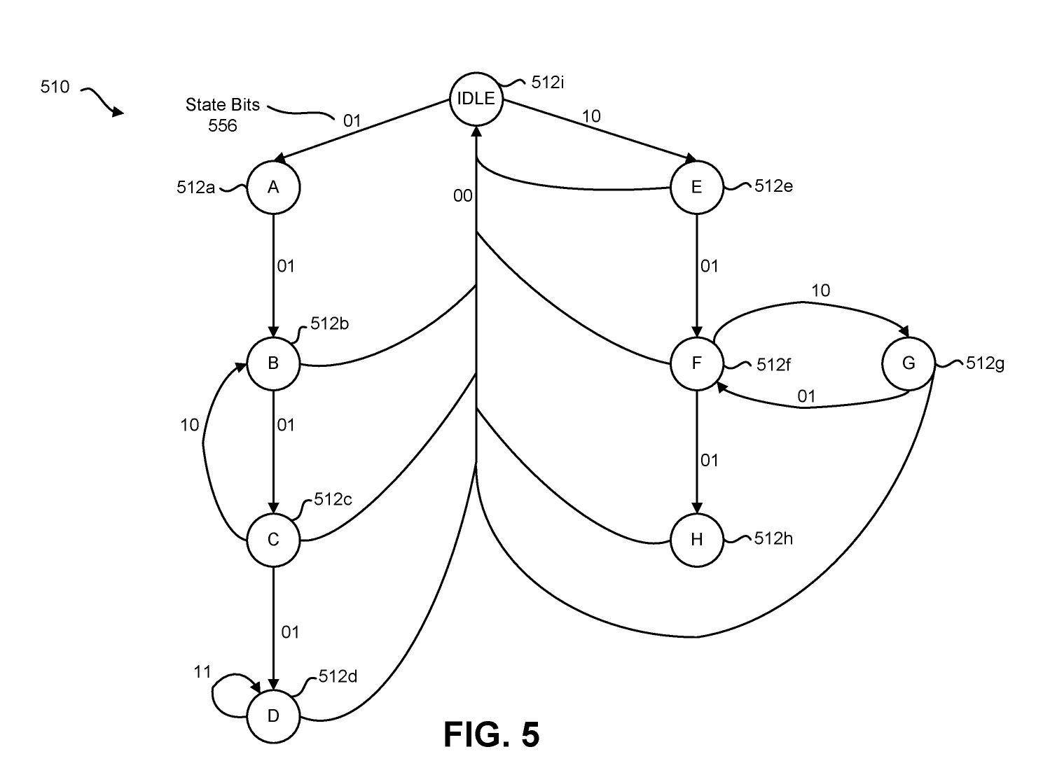

The controlling master IC 104 may include a master finite state machine (FSM) 110a that governs the operation of the slave IC 106. An FSM may include a number of predetermined states 112 that define a certain behavior for a given system (e.g., slave IC 106). The state 112 may correspond to a certain status of a system. A state transition 114 may be a set of actions that are executed in response to certain conditions. A state transition 114 may connect two states 112. For example, an IC may move from a first state 112 to a next state 112 upon performing the state transition 114 that connects the two states 112. A state transition 114 may also lead to the same state 112 from which it was initiated. An example of an FSM is described in connection with FIG. 5.

The master FSM 110a may be used to control the slave IC 106. The master IC 104 may include a number of states 112a and corresponding state transitions 114a. These states 112a and state transitions 114a of the master FSM 110a may be associated with operations that the master IC 104 wants the slave IC 106 to perform.

It should be noted that the states 112 and state transitions 114 may be predetermined. In other words, the states 112 of an IC and the actions taken when transitioning between states 112 may be fixed. However, the series of states 112 and state transitions 114 that are selected are variable. For example, the master IC 104 may determine from among a plurality of states 112a a certain state 112a to move to next. Therefore, the master IC 104 need not move through the master FSM 110a in a fixed sequence. Instead, the sequence of states 112a and state transitions 114a may be arbitrary. This allows the master IC 104 to respond to varying conditions by instructing the slave IC 106 to implement different operations.

The slave IC 106 may also include a slave FSM 110b. The slave FSM 110b may be equivalent to the master FSM 110a. In other words, the states 112a or state transitions 114a of the master FSM 110a may correspond to equivalent states 112b or state transitions 114b of the slave FSM 110b.

The slave IC 106 may implement one or more operations based on the states 112b or state transitions 114b of the slave FSM 110b. However, because the slave IC 106 is controlled by the master IC 104, the master IC 104 may instruct the slave IC 106 when and how to step through the slave FSM 110b.

The master IC 104 and the slave IC 106 may be coupled via a control interface 108. To minimize the IO connections, this control interface 108 is implemented as a single wire. As used herein, a wire may be an electrical connection (e.g., trace, connector, pin, ball or other connection means). Therefore, the control interface 108 is implemented as a single electrical connection between the master IC 104 and the slave IC 106.

The master IC 104 may determine how to step through the master FSM 110a. For example, depending on the current state 112a of the master FSM 110a, the master IC 104 may choose a given state transition 114. The master FSM 110a may communicate the selected state 112a or state transition 114a to the slave IC 106.

In one approach, the master IC 104 may communicate a certain state 112a that the slave IC 106 should move to. For example, the master IC 104 may communicate to the slave IC 106 to move from State-A to State-B or from State-A to State-E. The slave IC 106 may then perform a state transition 114b as mapped in the slave FSM 110b.

In another approach, the master IC 104 may communicate a certain state transition 114b that the slave IC 106 should perform from the current state 112b. Because the state transitions 114b are mapped to a subsequent state 112b in the slave FSM 110b, upon receiving the state transition 114a from the master IC 104, the slave IC 106 knows how to step through the slave FSM 110b.

In an implementation, the master FSM 110a may send an encoded signal across the control interface 108 to the slave IC 106 to indicate the selected state 112a or state transition 114a. This encoded signal may include a number of bits. For example, a start bit may initiate communication. The master IC 104 may then send a number of state bits. As used herein, state bits may indicate a state 112 or a state transition 114. In other words, state bits may indicate a certain state 112 that the master FSM 110a and slave FSM 110b are to enter. In this configuration, each state 112 may have a unique state bit combination. Alternatively, state bits may indicate a state transition 114 from one state 112 to another state 112.

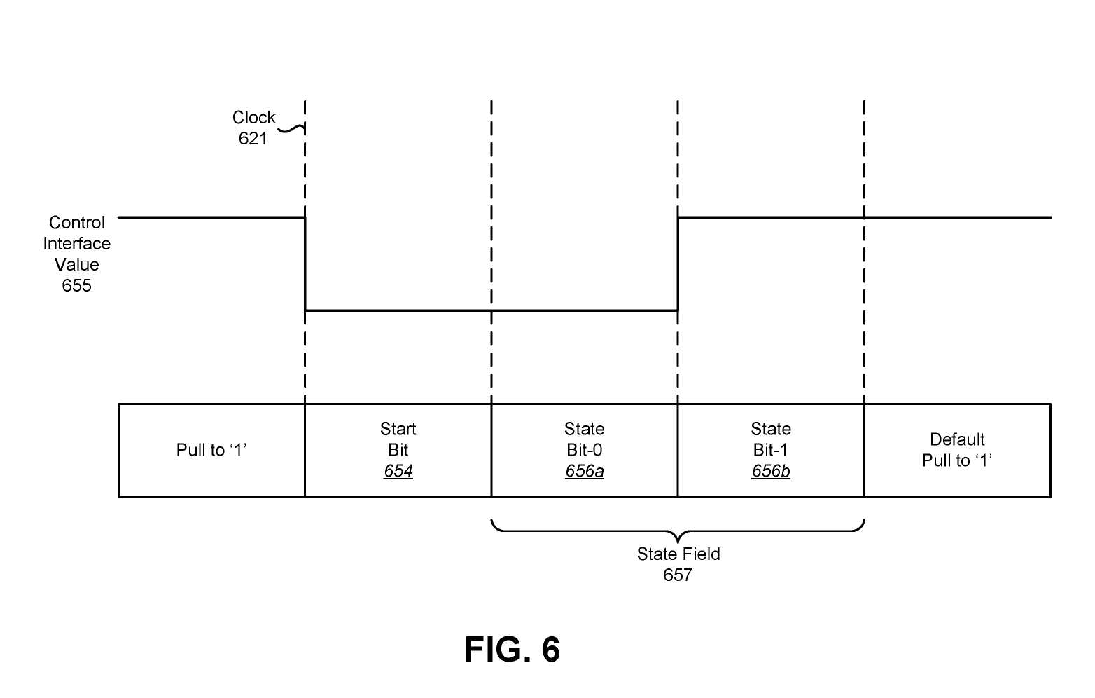

The state bits may instruct the slave IC 106 how to step from the current state 112b. For example, the state bits may indicate which state 112b to transition to and which actions to take during the transition. Additionally, the state bits may indicate to remain in the current state 112b. An example of a single-wire transaction with state data is described in connection with FIG. 6.

The slave IC 106 may include a synchronization module 116. As used herein, a “module” may be implemented in hardware (e.g., circuitry), software executed by a processor or a combination of hardware and software. The synchronization module 116 may receive the states 112a or state transitions 114a from the master IC 104 via the control interface 108. For example, the synchronization module 116 may receive the state bits from the master FSM 110a.

The synchronization module 116 may decode the master FSM's states 112a or state transitions 114a. For example, the synchronization module 116 may decode the state bits. The synchronization module 116 may use the decoded states 112a or state transitions 114a to step the slave FSM 110b in real time such that the states 112b or state transitions 114b in the slave FSM 110b mirror the states 112a or state transitions 114a in the master FSM 110a. For example, the state bits may instruct the slave FSM 110b to move from the current state 112b to a next state 112b.

Because the master FSM 110a and the slave FSM 110b are equivalent, the slave FSM 110b moves in lockstep with the master FSM 110a. As used herein, “step” refers to instructing the slave FSM 110b to match the master FSM 110a. The master FSM 110a communicates its current state 112a or state transition 114a to cause the slave FSM 110b to match with the same state 112a or state transition 114a. The slave IC 106 may then perform one or more operations based on the states 112a or state transitions 114a communicated from the master IC 104.

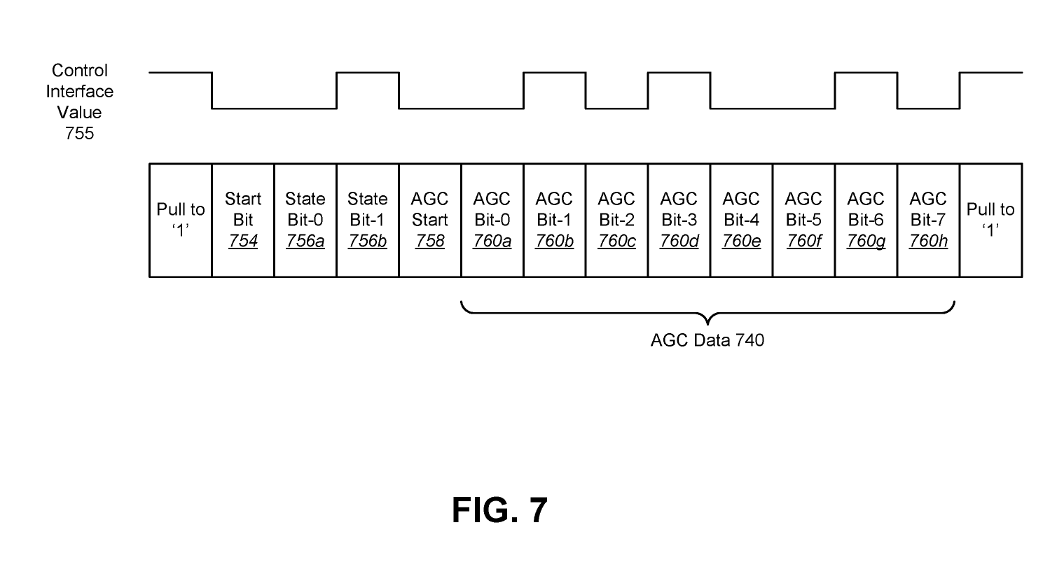

The master FSM 110a may communicate additional control data 124 to the slave IC 106 via the control interface 108. In an implementation, the master FSM 110a may send an additional bit indicating that other control data 124 will also be sent. The master FSM 110a may then send the additional control data 124 to the slave IC 106. Examples of the additional control data 124 that may be communicated to the slave IC 106 include automatic gain control (AGC) data, receive (RX) power control, RX control, transmit (TX) control, TX power control or volume control. An example of a single-wire transaction with state data and AGC data is described in connection with FIG. 7.

In an approach, the slave IC 106 may include a clock 120. The clock 120 may generate a clock signal for synchronizing the master FSM 110a and the synchronization module 116. The clock signal may be sent to the master IC 104 via a clock interface 122 that is separate from the control interface 108. The master FSM 110a may determine when to communicate its states 112a or state transitions 114a based on the clock signal. For example, the master FSM 110a may send state bits at clock signal edges. The synchronization module 116 in the slave IC 106 may synchronize the incoming data from the master IC 104 via the fast sampling clock 120 to maintain lock with the master FSM 110a.

In an implementation, the master IC 104 may share the control interface 108 with a separate register programming interface 126. The register programming interface 126 may control the programming of registers in the slave IC 106. The master IC 104 may perform time multiplexing of the control interface 108 between the master FSM 110a and the register programming interface 126. In an implementation, the register programming interface 126 may use a serial programming scheme (e.g., Inter-Integrated Circuit (I2C), Single-Wire Serial Bus Interface (SSBI)). However, it should be noted that serial programming schemes typically suffer from high latency and are restricted to register control. Therefore, serial programming schemes are inadequate to control the slave IC 106 in real time.

In another implementation, the master IC 104 may control multiple slave ICs 106. Each of the slave ICs 106 may be coupled to the master IC 104 via a single-wire control interface 108. The master FSM 110a may communicate its states 112a or state transitions 114a to each of the plurality of slave ICs 106 as described above. The plurality of slave ICs 106 may use the states 112a or state transitions 114a of the master FSM 110a to step their respective slave FSMs 110b in real time such that states 112b or state transitions 114b in the slave FSMs 110b mirror the states 112a and state transitions 114a of the master FSM 110a. In other words, the multiple slave ICs 106 may move in lockstep with the master FSM 110a.

Different approaches may be used to synchronize the plurality of slave FSMs 110b to the master FSM 110a. In the case where there is a single master IC 104 and multiple slave ICs 106, in one approach, the implementation described above may be modified so that the master IC 104 is responsible for generating a clock 120 and distributing the clock signal via the clock interface 122 to multiple slave ICs 106.

In another approach, one of the slave ICs 106 may be responsible for distributing the clock 120 to the master IC 104 and other slave ICs 106. Another approach is that a completely different synchronization scheme may be implemented to synchronize all the ICs 104, 106 while each slave IC 106 generates its own internal clock 120.

In the case of mixed-signal devices, the clock 120 generation is a critical part of making RFICs function properly at high RF frequencies. Therefore, the RFICs may generate and distribute the clock 120. However, other schemes are possible to synchronize the control interface 108.

In yet another approach, the synchronization can be implemented without a distributed clock. In this approach, each slave IC 106 may oversample the control interface 108 and base its sampling time of the control interface 108 on the falling edge (i.e., 1 to 0 transition) of a start bit 654. This approach uses an asynchronous control interface 108 (i.e. no clock signal) where the slave IC 106 oversamples the control data 124.

It should be noted that there are many additional ways to synchronize ICs 104, 106. It should also be noted that any of these modified synchronization approaches can also be used in the case of a single master IC 104 and a single slave IC 106.

An example use case for a multiple slave IC 106 implementation is MIMO, where multiple slave ICs 106 each include one or more antennas. These antennas do the same thing but have different orientations and spacing. The master IC 104 may communicate the same sequence of states 112a and state transitions 114a to the multiple slave ICs 106 to perform MIMO operations.

In an approach, the master IC 104 may communicate with the plurality of slave ICs 106 without feedback from the slave ICs 106. In this approach, the master FSM 110a may broadcast its states 112a and state transitions 114a to the plurality of slave ICs 106. The master IC 104 may configure beforehand which slave ICs 106 participate using serial programming (e.g., SSBI).

The systems and methods described herein provide for control of a slave IC 106 by a master IC 104 via a single-wire control interface 108. Specifically, single-wire control of an entire slave IC 106 by the master IC 104 may be performed. The control flow of the master FSM 110a is communicated to the slave IC 106 via a single wire. This minimizes the number of IO connections between the master IC 104 and the slave IC 106. The master control flow is decoded and used to drive the slave FSM 110b within the slave IC 106 in real time. Additionally, the described systems and methods provide for arbitrary state control, which allows the master IC 104 to vary the sequence of states 112 in response to changing conditions.

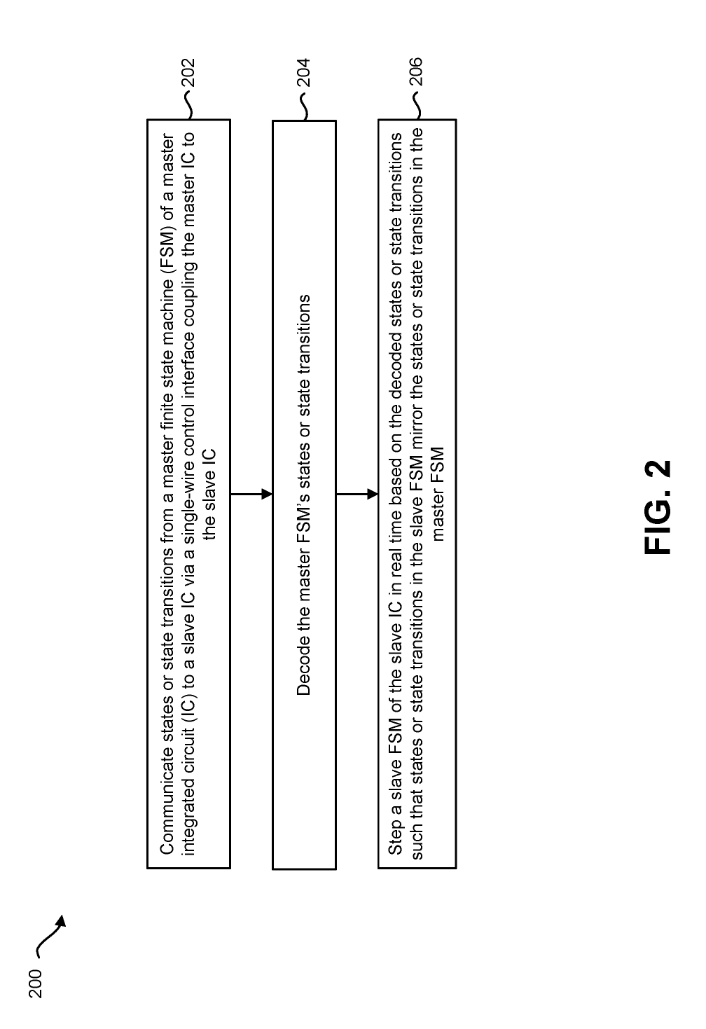

FIG. 2 is a flow diagram illustrating a method 200 for single-wire control of a slave integrated circuit (IC) 106 by a master IC 104. The method 200 may be performed by an electronic device 102 configured with a master IC 104 that is coupled to the slave IC 106 via a single-wire control interface 108. In an implementation, the master IC 104 may be a digital baseband (BB) IC and the slave IC 106 may be a radio frequency integrated circuit (RFIC).

The electronic device 102 may communicate 202 states 112a or state transitions 114a from a master finite state machine (FSM) 110a of the master IC 104 to the slave IC 106 via the control interface 108. For example, the master FSM 110a may send its states 112a or state transitions 114a over the control interface 108 in encoded state bits.

The states 112a or state transitions 114a communicated by the master FSM 110a may be a variable series of states 112a or state transitions 114a. For a current state 112a in the master FSM 110a, the master IC 104 may determine a subsequent state 112a. The master IC 104 may also determine when to transition to a subsequent state 112a. Therefore, the master IC 104 may implement arbitrary state control.

The electronic device 102 may decode 204 the master FSM's states 112a or state transitions 114a. For example, a synchronization module 116 of the slave IC 106 may receive the state bits from the master FSM 110a. The synchronization module 116 may decode 204 the encoded state bits to determine how to transition to a subsequent state 112b of the slave FSM 110b.

The electronic device 102 may step 206 the slave FSM 110b in real time based on the decoded states 112a or state transitions 114a. For example, the synchronization module 116 may use decoded states 112a or state transitions 114a to cause the states 112b or state transitions 114b in the slave FSM 110b to mirror the master FSM 110a.

In an implementation, the slave IC 106 may communicate a clock signal via a clock interface 122. The master FSM 110a and the synchronization module 116 may synchronize communication of the master FSM's states 112a or state transitions 114a based on this clock signal. This allows the master IC 104 to control the slave FSM 110b in real time.

FIG. 3 is a block diagram illustrating a configuration of a mixed-signal device 302 configured for single-wire control of an analog IC 306 by a digital IC 304. The mixed-signal device 302 may be implemented in accordance with the electronic device 102 described in connection with FIG. 1.

A mixed-signal device 302 may use multiple ICs to perform various operations. A mixed-signal device 302 may use separate ICs instead of a single IC to reduce manufacturing costs and development time. In an example, a mixed-signal device 302 may include a digital IC 304 to process digital information. The mixed-signal device 302 may include a separate analog IC 306 that has analog radio components (e.g., transmitter(s) and/or receiver(s)). It is beneficial to minimize the number of IO allocated to control the analog IC 306.

In this implementation, the digital IC 304 is the master. The digital IC 304 may include various components for performing digital processing. The digital IC 304 may also include a digital processor 332 configured to send or receive TX/RX data 338. The digital IC 304 may further include a control module 334 that determines control data 340a based on RX data 336 received from the analog IC 306. Examples of the control data 340a include AGC data, receive RX power control, RX control, transmit TX control, TX power control or volume control.

The analog IC 306 may be used as a slave. The analog IC 306 may include various analog components. For example, the analog IC 306 may include an analog processor 352. The analog IC 306 may also include a control module 346 that determines an analog control 348 for the analog processor 352 based on control data 340b provided by the digital IC 304.

The digital IC 304 may determine how to control the analog IC 306. For example, a high level FSM 328 may send a control signal 330 to the master FSM 310a of the digital IC 304. As described above, the master FSM 310a may include various states 112a or state transitions 114a to control the operation of the analog IC 306. The high level FSM 328 may determine which state 112a or state transitions 114a should be selected. The high level FSM 328 then communicates this selection to master FSM 310a via a control signal 330. Alternatively, the master FSM 310a may make the state transition decisions independent of the high level FSM 328.

The master FSM 310a maps out a series of operations that may be run by the analog IC 306 in a certain order. In this implementation, the analog IC 306 is the slave. The analog IC 306 has a slave FSM 310b to be able to step through the selected states 112b. However, the slave FSM 310b needs to be told by the master FSM 310a when to step through those states 112b. Furthermore, it is desirable to be able control the analog IC 306 with as few IO connections (e.g., pins) as possible. Therefore, a single-wire control interface 308 may be used to couple the digital IC 304 and the analog IC 306.

The controlling master FSM 310a of the digital IC 304 governs the operation of the analog IC 306. The control flow of the master FSM 310a is communicated to the analog IC 306 via the single-wire control interface 308. The master control flow may be decoded and used to drive the slave FSM 310b within the analog IC 306 in real time. It should be noted that the master FSM 310a and the slave FSM 310b may be equivalent. Therefore, the master FSM 310a and the slave FSM 310b may have identical states 112 and state transitions 114.

The analog IC 306 may include a synchronization (sync) module 316 that receives the communicated state 112 or state transition 114 from the master FSM 310a. The synchronization module 316 may decode the master FSM communication according to a control protocol used by the master FSM 310a.

In an implementation, the master FSM 310a may communicate a state 112 or state transition 114 via one or more state bits. A pull-up resistor 342 may be coupled to the control interface 308. The pull-up resistor 342 may pull the control interface 308 high. The digital IC 304 may communicate the state bits by pulling the control interface 308 low or allowing the pull-up resistor 342 to pull the control interface 308 high.

The master FSM 310a may transmit the state bits and (optional) control data 340a. Control of the control interface 308 is then released.

The synchronization module 316 may receive the state bits and (optional) control data 340a. The synchronization module 316 may decode the data sent from the master FSM 310a. For example, the synchronization module 316 may determine how to step through the slave FSM 310b based on the received state bits. Each state 112b of the slave FSM 310b may have a mapping to the state bits. This mapping may indicate the state 112b and/or state transition 114b of the slave FSM 310b. The synchronization module 316 may use the state bits to step the slave FSM 310b in real time such that states 112b or state transitions 114b in the slave FSM 310b mirror the states 112a or state transitions 114a in the master FSM 310a.

The analog IC 306 may perform one or more operations based on the slave FSM 310b. For example, the slave FSM 310b may send a state control signal 350 to the analog processor 352 based on the current state 112b or state transition 114b.

In the case that the master FSM 310a sends control data 340a, the synchronization module 316 may receive the control data 340a. The synchronization module 316 may provide the control data 340a to the slave FSM 310b, which may forward the control data 340b to the control module 346.

The synchronization module 316 and the slave FSM 310b in the analog IC 306 may synchronize the incoming data via a sampling clock 320 in order to maintain lock with the master FSM 310a. The clock 320 may generate a clock signal 321 that acts as a heartbeat for the whole system. The clock signal 321 may be provided to the synchronization module 316 and the slave FSM 310b. The clock signal 321 may also be sent to the digital IC 304 via a separate clock interface 322. The digital IC 304 may use the same clock signal 321 to control when to communicate with the analog IC 306. In another implementation, the digital IC 304 may generate the clock signal 321, which is provided to the analog IC 306 for synchronization.

Without a clock 320 to synchronize communication, the digital IC 304 and the analog IC 306 would communicate at a much slower rate. This will result in problems where the master FSM 310a and the slave FSM 310b are not in lockstep. In other words, without a synchronization clock 320, there will be a lag in the communication between the digital IC 304 and the analog IC 306, which will negatively impact the operation of the system.

Transmitted and received (TX/RX) data 338 may be communicated between the digital IC 304 and the analog IC 306 on a separate TX/RX data interface 344. The TX/RX data interface 344 may include one or more connections (i.e., wires). Therefore, the RF operations of the analog IC 306 and digital IC 304 may be separated from the control operations on the control interface 308. Because of this separation, the master FSM 310a may control the slave FSM 310b during TX/RX operations.

A register programming interface 126 may also be included in the digital IC 304. It may be implemented by time multiplexing the control interface 308. In an example, SSBI or I2C could fit on the same physical control interface 308. Alternatively, the register programming interface 126 may use a separate wire.

FIG. 4 is a block diagram illustrating a configuration of a wireless communication device 402 configured for single-wire control of a radio frequency IC (RFIC) 406 by a digital baseband IC (BB IC) 404. The wireless communication device 402 may be implemented in accordance with the electronic device 102 described in connection with FIG. 1.

Some wireless communication devices 402 may utilize multiple communication technologies or protocols. For example, one communication technology may be utilized for mobile wireless system (MWS) (e.g., cellular) communications, while another communication technology may be utilized for wireless connectivity (WCN) communications. MWS may refer to larger wireless networks (e.g., wireless wide area networks (WWANs), cellular phone networks, Long Term Evolution (LTE) networks, Global System for Mobile Communications (GSM) networks, code division multiple access (CDMA) networks, CDMA2000 networks, wideband CDMA (W-CDMA) networks, Universal mobile Telecommunications System (UMTS) networks, Worldwide Interoperability for Microwave Access (WiMAX) networks, etc.). WCN may refer to relatively smaller wireless networks (e.g., wireless local area networks (WLANs), wireless personal area networks (WPANs), IEEE 802.11 (Wi-Fi) networks, Bluetooth (BT) networks, IEEE 802.15.4 (e.g., ZigBee) networks, wireless Universal Serial Bus (USB) networks, etc.).

Communications in a wireless communication system (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

A wireless communication device 402 is an electrical device that is configured to communicate using one or more communication protocols. A wireless communication device 402 may also be referred to as a wireless device, a mobile device, mobile station, subscriber station, client, client station, user equipment (UE), remote station, access terminal, mobile terminal, terminal, user terminal, subscriber unit, etc. Examples of wireless communication devices 402 include laptop or desktop computers, cellular phones, smartphones, wireless modems, e-readers, tablet devices, gaming systems, keyboards, keypads, computer mice, remote controllers, headsets, smoke detectors, sensors, etc. A wireless communication device 402 may be a mobile device (e.g., a smartphone) or it may be primarily in a fixed location (e.g., a desktop computer).

A wireless communication device 402 may use multiple ICs to perform various operations. A wireless communication device 402 may use separate ICs instead of a single IC to reduce manufacturing costs and development time. In an example, a wireless communication device 402 may include a digital baseband (BB) IC 404 to process digital information associated with wireless communication. The wireless communication device 402 may include a separate radio frequency IC (RFIC) 406 that has analog radio components (e.g., transmitter(s) and/or receiver(s)).

The wireless communication device 402 may include a digital baseband IC (BB IC) 404 and a radio frequency IC (RFIC) 406. One or more RFICs 406 are often used in conjunction with a BB IC 404 to form the physical (PHY) layer of a wireless communication system. When the radio frequency (RF) and baseband (BB) functions are implemented on separate ICs it is desirable to minimize the number IO connections between them in order to reduce cost. The IO count is dominated by the width of ADC data passed between the ICs, but it is desirable to allow the BB IC 404 to maintain control of the RFIC 406 during operation. It is beneficial to minimize the number of IO allocated to control the RFIC 406.

The BB IC 404 may be implemented as a separate chip from the RFIC 406. This is a functional solution where two separate chips may be used in the same wireless communication device 402. For example, to perform RF operations, the RFIC 406 may be implemented as a very specialized gallium arsenide chip to achieve a very efficient or low power radio. The BB IC 404 may be implemented as a complementary metal-oxide-semiconductor (CMOS) chip, for example. It should be noted that other configurations of the BB IC 404 and RFIC 406 may be used.

It is very common to have multiple chips in a wireless system. For instance, RF circuits are often implemented using special process technologies or larger chip area to enhance RF performance, whereas digital circuits are usually packed tightly to reduce chip area and lower power consumption.

In this implementation, the BB IC 404 is the master. The BB IC 404 may include various components for performing digital baseband processing. For example, the BB IC 404 may include a modem and/or one or more protocol layers. The BB IC 404 may also include a baseband processor 432 configured to send or receive TX/RX data 438. The BB IC 404 may further include an automatic gain control (AGC) circuit 434 that may determine AGC data 440a based on RX data 436 received from the RFIC 406.

The RFIC 406 may be used as a slave. The RFIC 406 may include various RF components. For example, the RFIC 406 may include a radio frequency analog (RFA) block 452 that includes a receiver and/or transmitter. The RFIC 406 may also include an RFA gain module 446 that determines the gain for the RFA block 452 based on AGC data 440b provided by the BB IC 404. It should be noted that the AGC data 440b decoded by the RFIC 406 is equivalent to the AGC data 440a that was generated by the BB IC 404. The RFA gain module 446 may communicate the gain to the RFA 452 via a gain control signal 448.

The BB IC 404 may determine how to control the RFIC 406. For example, a high level FSM 428 may send a control signal 430 to the master FSM 410a of the BB IC 404. As described above, the master FSM 410a may include various states 112a or state transitions 114a to control the operation of the RFIC 406. The high level FSM 428 may determine which state 112a or state transitions 114a should be selected. The high level FSM 428 then communicates this selection to master FSM 410a via a control signal 430. Alternatively, the master FSM 410a may make the state transition decisions independent of the high level FSM 428.

The master FSM 410a maps out a series of operations that may be run by the RFIC 406 in a certain order. In this implementation, the RFIC 406 is the slave. The RFIC 406 has a slave FSM 410b to be able to step through the selected states 112b. However, the slave FSM 410b needs to be told by the master FSM 410a when to step through those states 112b. Furthermore, it is desirable to be able control the RFIC 406 with as few IO connections (e.g., pins) as possible. Therefore, a single-wire control interface 408 may be used to couple the BB IC 404 and the RFIC 406.

The controlling master FSM 410a of the BB IC 404 governs the operation of the RFIC 406. The control flow of the master FSM 410a is communicated to the RFIC 406 via the single-wire control interface 408. The master control flow may be decoded and used to drive the slave FSM 410b within the RFIC 406 in real time. It should be noted that the master FSM 410a and the slave FSM 410b may be equivalent. Therefore, the master FSM 410a and the slave FSM 410b may have identical states 112 and state transitions 114.

The RFIC 406 may include a synchronization (sync) module 416 that receives the communicated state 112 or state transition 114 from the master FSM 410a. The synchronization module 416 may decode the master FSM communication according to a control protocol used by the master FSM 410a.

An example of a control protocol is provided herein. It should be noted that other configurations of a control protocol may be used. In the described control protocol, a default state of the control interface 408 is “1”. This may be achieved by a pull-up resistor 442 that is coupled to the control interface 408, which is pulled high via the pull-up resistor 442. Communication may be initiated from the BB IC 404 side by pulling the control interface 408 low. For example, the master FSM 410a may pull the control interface 408 low to generate a start bit that indicates the beginning of communication. It should be noted that in another implementation, a pull down resistor may be used. In this implementation, the control protocol described herein may be inverted.

The master FSM 410a may send a variable number of state bits on the control interface 408. The state bits may represent a state transition 114 or an actual state 112 value. The state bits may be sent from least-significant bits (LSBs) to most-significant bits (MSBs). Alternatively, the state bits may be sent from MSB to LSB. The number of state bits may vary depending on the complexity of the control finite state machine. For example, more complex finite state machines may require more state bits. Examples of the control protocol are described in connection with FIG. 6 and FIG. 7.

In an implementation, two state bits may be used. An example of the state bit code is provided in Table 1. An example of how this control protocol may be used to step through a finite state machine is described in connection with FIG. 5.

TABLE 1

| State Bit Code | Meaning |
|---|---|
| 00 | Return to Idle State |
| 01 | Branch to next state (e.g., State-A) |
| 10 | Branch to next state (e.g., State-E) |
| 11 | Remain in current state (e.g., when |
| | sending AGC control data) |

The BB IC 404 may send additional control data 124 to the RFIC 406 via the control interface 408. The control data 124 may include AGC data 440a. The control data 124 may also include receive RX power control, RX control, transmit TX control or TX power control.

In an implementation of the control protocol, the master FSM 410a may send an additional bit after the state bits. The additional bit indicates the presence of additional control data 124 following the state bits. In the case of AGC data 440a, the additional bit may indicate the presence of optional AGC control data 440a. In an implementation, “0” means AGC control data will be sent and “1” means no more data.

The master FSM 410a may transmit the state bits and (optional) control data 124. Control of the control interface 408 is then released.

The synchronization module 416 may receive the state bits and (optional) control data 124. The synchronization module 416 may decode the data sent from the master FSM 410a. For example, the synchronization module 416 may determine how to step through the slave FSM 410b based on the received state bits. Each state 112b of the slave FSM 410b may have a mapping to the state bits. This mapping may indicate the state 112b and/or state transition 114b of the slave FSM 410b. The synchronization module 416 may use the state bits to step the slave FSM 410b in real time such that states 112b or state transitions 114b in the slave FSM 410b mirror the states 112a or state transitions 114a in the master FSM 410a.

The RFIC 406 may perform one or more operations based on the slave FSM 410b. For example, the slave FSM 410b may send a control signal 450 to the RFA block 452 based on the current state 112b or state transition 114b. The control signal 450 may indicate to the RFA block 452 to enable the transmitter or receiver.

In the case that the master FSM 410a sends AGC data 440a, the synchronization module 416 may receive the AGC data 440a. The synchronization module 416 may provide the AGC data 440a to the slave FSM 410b, which may forward the AGC data 440b to the RFA gain module 446. It should be noted that AGC data 440b is equivalent to AGC data 440a.

The synchronization module 416 and the slave FSM 410b in the RFIC 406 may synchronize the incoming data via a fast sampling clock 420 in order to maintain lock with the master FSM 410a. The clock 420 may generate a clock signal 421 that acts as a heartbeat for the whole system. The clock signal 421 may be provided to the synchronization module 416 and the slave FSM 410b. The clock signal 421 may also be sent to the BB IC 404 via a separate clock interface 422. The BB IC 404 may use the same clock signal 421 to control when to communicate with the RFIC 406. In another implementation, the BB IC 404 may generate the clock signal 421, which is provided to the RFIC 406 for synchronization.

Without a clock 420 to synchronize communication, the BB IC 404 and the RFIC 406 would communicate at a much slower rate. This will result in problems where the master FSM 410a and the slave FSM 410b are not in lockstep. In other words, without a synchronization clock 420, there will be a lag in the communication between the BB IC 404 and the RFIC 406, which will negatively impact the operation of the system.

It should be noted that without clock synchronization the slave RFIC 406 can still oversample the control interface 408 to establish communication. This approach may introduce a small lag. However, this is a viable solution, especially in the cases where the wireless communication device 402 does not have the means to distribute the clock signal 421.

The number of control states 112 and width of AGC control data 440 may be predetermined. The master FSM 410a and the slave FSM 410b may have a predetermined set of states 112 and state transitions 114. Likewise, the AGC data 440 may use a predetermined number of bits.

Transmitted and received (TX/RX) data 438 may be communicated between the BB IC 404 and the RFIC 406 on a separate TX/RX data interface 444. The TX/RX data interface 444 may include one or more connections (i.e., wires). Therefore, the RF operations of the RFIC 406 and BB IC 404 may be separated from the control operations on the control interface 408. Because of this separation, the master FSM 410a may control the slave FSM 410b during TX/RX operations.

A register programming interface 126 may also be included in the BB IC 404. It may be implemented by time multiplexing the control interface 408. In an example, SSBI or I2C could fit on the same physical control interface 408. Alternatively, the register programming interface 126 may use a separate wire.

The advantages of the described wireless communication device 402 include the following. The IO count between the BB IC 404 and the RFIC 406 is minimized. Control to the RFIC 406 allows real time operation of the wireless communication control protocol. The control protocol is distinct from serial programming schemes, which typically suffer from high latency and are restricted to register control.

FIG. 5 illustrates an example of a master and slave FSM 510 for two encoded state bits 556 where the encoded state bits 556 in this example represent the actual state transitions. The FSM 510 described in connection with FIG. 5 may be an implementation of the master FSM 110a, 310a, 410a or slave FSM 110b, 310b, 410b described in connection with FIG. 1, FIG. 3 and FIG. 4. This is an example of the control protocol described in connection with FIG. 4.

The FSM 510 includes multiple states 512a-i. A slave IC 106 may perform certain operations while in a given state 512 or when transitioning from one state 512 to another state 512.

In this example, the two state bits 556 indicate how to step from a given state 512. These state bits 556 may be generated by the master IC 104 and sent to the slave IC 106 over a single-wire control interface 108. Two state bits 556 form a state bit code. For each state 512, the state bits 556 may indicate whether to return to an IDLE state 512i, move to a next state 512 or remain on the current state 512.

In an example sequence, starting at the IDLE state 512i, a 01 state bit code indicates a step to State-A 512a while a “10” state bit code indicates a step to State-E 512e. At State-A 512a, a “01” state bit code indicates a step to State-B 512b. At State-B 512b, a “01” state bit code indicates a step to State-C 512c and a “00” state bit code indicates a step back to the IDLE state 512i, and so forth.

At State-D 512d, a “11” state bit code indicates that the FSM 510 is to remain at the current state (i.e., State-D 512d). For example, this may be used when sending AGC data 440.

It should be noted that the states 512 in the FSM 510 are predetermined. Therefore, the states 512 and the actions taken when transitioning between states 512 may be fixed. However, the series of selected states 512 may vary. For example, for a given state 512, the master IC 104 may step to one of a plurality of subsequent states 512. Therefore, the sequence of selected states 512 may be arbitrary.

FIG. 6 illustrates an example of a single-wire transaction according to the control protocol described herein. Specifically, FIG. 6 shows a timing diagram for communication on the single-wire control interface 108. In this example, the state is “10,” and there is no AGC data.

At the beginning of the transaction, the control interface value 655 is high (e.g., pulled to “1”). This may be accomplished by a pull-up resistor 442 pulling the control interface 108 high.

A start bit 654 may initiate communication. For example, the master IC 104 may pull the control interface 108 low. After the start bit 654, state bit-0 656a is low while state bit-1 656b is high. In this implementation, the state bits 656 are sent LSB to MSB. Therefore, the two state bits 656 indicate a state bit code of “10.” The two state bits 656 form a state field 657.

At the end of the transaction, the control interface value 655 is pulled high (e.g., to “1”). This indicates that there is no additional control data 124 to be transmitted.

It should be noted that the transaction may be synchronized by a clock signal 621. In this example, the bits 654, 656 are sent at the edge of a clock signal 621.

FIG. 7 illustrates an example of another single-wire transaction according to the control protocol described herein. Specifically, FIG. 7 shows a timing diagram for communication on the single-wire control interface 108. In this example, the state is “10,” and the AGC data is “01001010.” It should be noted that the transaction may be synchronized by a clock signal 321 (not shown).

At the beginning of the transaction, the control interface value 755 is high (e.g., pulled to “1”). This may be accomplished by a pull-up resistor 442 pulling the control interface 108 high.

A start bit 754 may initiate communication. For example, the master IC 104 may pull the control interface 108 low. After the start bit 754, state bit-0 756a is low while state bit-1 756b is high. In this implementation, the state bits 756 are sent LSB to MSB. Therefore, the two state bits 756 indicate a state bit code of “10.”

After the state bits 756, the control interface value 755 is pulled low (e.g., to “0”). This indicates that AGC data 740 will be sent. The master IC 104 sends 8 AGC bits 760a-h with a value of “01001010” (LSB to MSB). At the end of the transaction, the control interface value 755 is pulled high (e.g., to “1”). This indicates that there is no additional control data 124 to be transmitted.

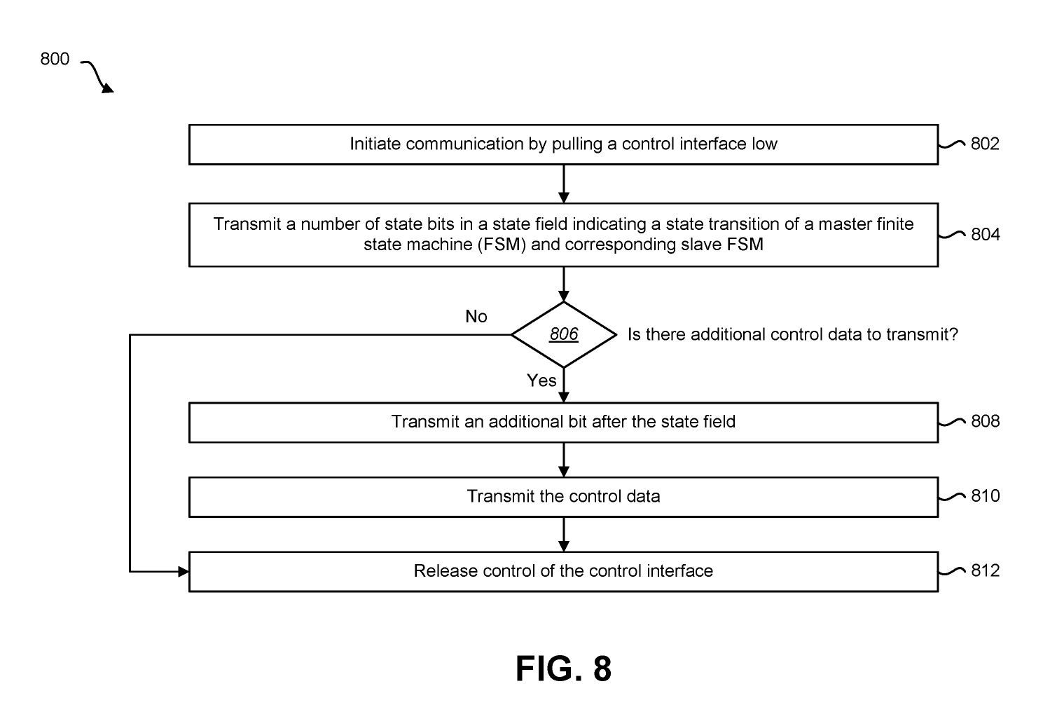

FIG. 8 is a flow diagram illustrating another method 800 for single-wire control of a slave integrated circuit (IC) 106 by a master IC 104. The method 800 may be performed by a master IC 104 that is coupled to the slave IC 106 via a single-wire control interface 108. In an implementation, the master IC 104 may be a digital IC 304 (e.g., digital baseband (BB) IC 404) and the slave IC 106 may be an analog IC 306 (e.g., radio frequency integrated circuit (RFIC) 406).

The master IC 104 may initiate 802 communication with the slave IC 106 by pulling the control interface 108 low. In an implementation, a pull-up resistor 442 may pull the control interface 108 high (e.g., to “1”) as a default. The master IC 104 may assume control of the control interface 108. The master IC 104 may then pull the control interface 108 low to indicate a start of transmission. This first low signal may be a start bit 654.

The master IC 104 may transmit 804 a number of state bits 656 in a state field 657. The state bits 656 may indicate a state transition 114a of a master FSM 110a and corresponding slave FSM 110b. In other words, the state bits 656 may indicate to a slave IC 106 which state 112b it should step to in its slave FSM 110b to mirror the master FSM 110a. The number of state bits 656 used in a state field 657 may depend on the complexity of the master FSM 110a.

The master IC 104 may determine 806 whether there is additional control data 124 to transmit to the slave IC 106. The control data 124 may include automatic gain control (AGC) data 440, receive (RX) power control, RX control, transmit (TX) control or TX power control.

If there is control data 124 to transmit, the master IC 104 may transmit 808 an additional bit after the state field 657. For example, in the case of AGC data 440, the master IC 104 may transmit 808 a single AGC start bit 758 after the last state bit 656. The master IC 104 may then transmit 810 the control data 124.

When the master IC 104 finishes transmitting 810 the additional control data 124, or if the master IC 104 determines 806 that there is no additional control data 124 to transmit, the master IC 104 may release 812 control of the control interface 108. The pull-up resistor 442 may pull the control interface 108 to high (e.g., to “1”).

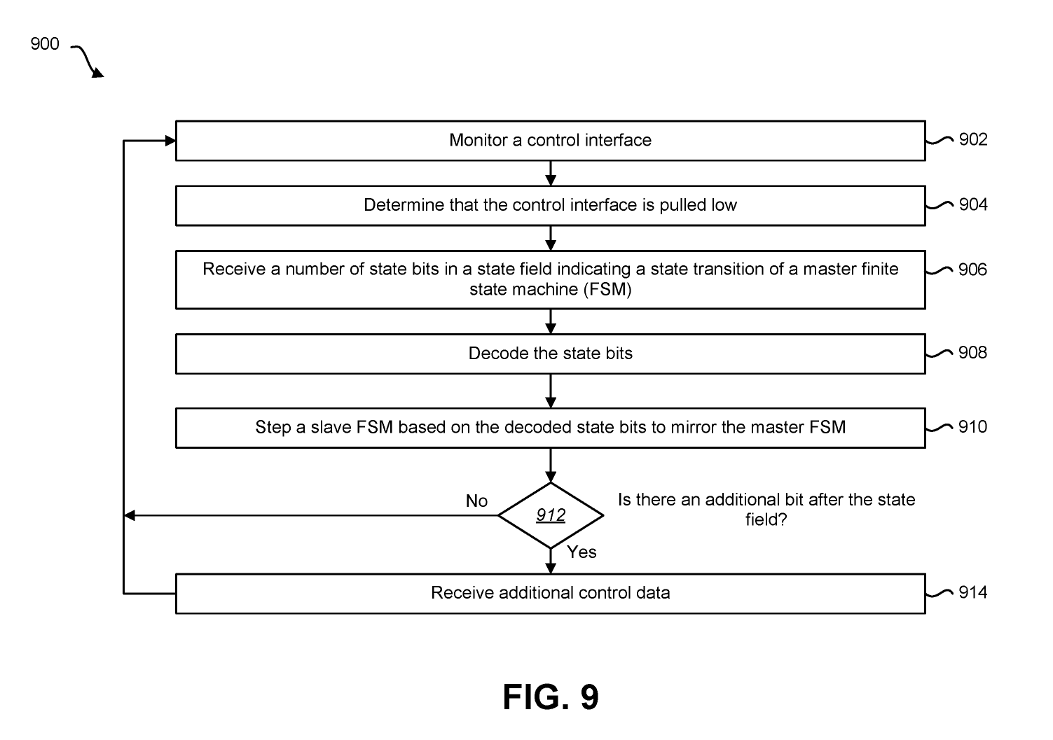

FIG. 9 is a flow diagram illustrating yet another method 900 for single-wire control of a slave integrated circuit (IC) 106 by a master IC 104. The method 900 may be performed by the slave IC 106 that is coupled to a master IC 104 via a single-wire control interface 108. In an implementation, the master IC 104 may be a digital IC 304 (e.g., digital baseband (BB) IC 404) and the slave IC 106 may be an analog IC 306 (e.g., radio frequency integrated circuit (RFIC) 406).

The slave IC 106 may monitor 902 the control interface 108. In an implementation, a pull-up resistor 442 may pull the control interface 108 high (e.g., to “1”) as a default. While in the default monitoring condition, if the control interface 108 is high, the slave IC 106 knows that the master IC 104 is not communicating with it on the control interface 108.

The slave IC 106 may determine 904 that the control interface 108 is pulled low. At some time, the master IC 104 may initiate communication with the slave IC 106 by pulling the control interface 108 low. The master IC 104 may assume control of the control interface 108. The master IC 104 may then pull the control interface 108 low to indicate a start of transmission. This first low signal may be a start bit 654. Upon detecting that the control interface 108 is pulled low, the slave IC 106 may prepare to receive a communication from the master IC 104.

The slave IC 106 may receive 906 a number of state bits 656 in a state field 657. The state bits 656 may indicate a state transition 114a of a master FSM 110a and corresponding slave FSM 110b. The slave IC 106 may decode 908 the state bits 656. For example, each state 112b in the slave FSM 110b may be mapped to state bits 656 that indicate certain state transitions 114b. The states 112a in the master FSM 110a are mapped to the same state bits 656 with corresponding state transitions 114a. Therefore the slave IC 106 interprets the state bits 656 as state transitions 114. For a given state 112b, the state bits 656 may instruct the slave FSM 110b on whether to enter an idle state 412i, whether to advance to a subsequent state 112b or remain on the current state 112b.

The slave IC 106 may step 910 its slave FSM 110b based on the decoded state bits to mirror the state transition of the master FSM 110a. The master FSM 110a and the slave FSM 110b may be equivalent. Therefore, upon receiving the state bits 656, the slave IC 106 steps 910 its slave FSM 110b to match the master FSM 110a. As part of stepping 910 the slave FSM 110b, the slave IC 106 may perform one or more operations associated with the state transitions 114b.

The slave IC 106 may determine 912 whether there is an additional bit after the state field 657. If there is an additional bit after the state field 657, then that indicates that the master IC 104 will be transmitting additional control data 124 to the slave IC 106. The control data 124 may include automatic gain control (AGC) data 440, receive (RX) power control, RX control, transmit (TX) control or TX power control. The slave IC 106 may receive 914 the additional control data 124 over the control interface 108.

When the slave IC 106 finishes receiving 914 the control data 124 or if the slave IC 106 determines 912 that there is no additional control data 124, the slave IC 106 may continue to monitor 902 the control interface 108 for additional communications from the master IC 104. The master IC 104 may release 912 control of the control interface 108 and the pull-up resistor 442 may pull the control interface 108 to high (e.g., to “1”).

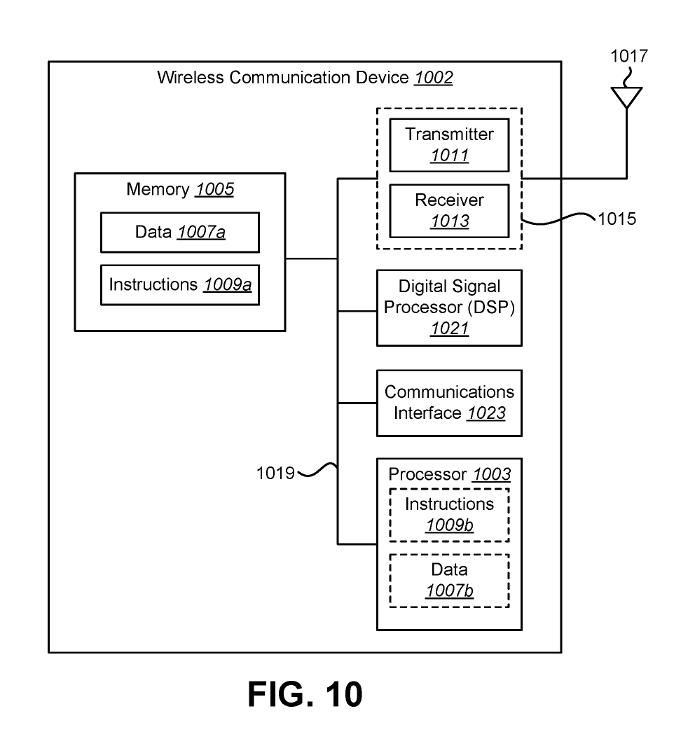

FIG. 10 illustrates certain components that may be included within an electronic device 1002. The electronic device 1002 described in connection with FIG. 10 may be an example of and/or may be implemented in accordance with the electronic device 102 described in connection with FIG. 1, the mixed-signal device 302 described in connection with FIG. 3 or the wireless communication device 402 described in connection with FIG. 4.

The electronic device 1002 includes a processor 1003. The processor 1003 may be a general purpose single- or multi-core microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1003 may be referred to as a central processing unit (CPU). Although just a single processor 1003 is shown in the electronic device 1002 of FIG. 10, in an alternative configuration, a combination of processors (e.g., an ARM and DSP) could be used.

The electronic device 1002 also includes memory 1005 in electronic communication with the processor 1003 (i.e., the processor can read information from and/or write information to the memory). The memory 1005 may be any electronic component capable of storing electronic information. The memory 1005 may be configured as Random Access Memory (RAM), Read-Only Memory (ROM), magnetic disk storage media, optical storage media, flash memory devices in RAM, on-board memory included with the processor, Erasable Programmable Read-Only Memory (EPROM), Electrically Erasable Programmable Read-Only Memory (EEPROM), registers and so forth, including combinations thereof.

Data 1007a and instructions 1009a may be stored in the memory 1005. The instructions 1009a may include one or more programs, routines, sub-routines, functions, procedures, code, etc. The instructions 1009a may include a single computer-readable statement or many computer-readable statements. The instructions 1009a may be executable by the processor 1003 to implement the methods disclosed herein. Executing the instructions 1009a may involve the use of the data 1007a that is stored in the memory 1005. When the processor 1003 executes the instructions 1009, various portions of the instructions 1009b may be loaded onto the processor 1003, and various pieces of data 1007b may be loaded onto the processor 1003.

The electronic device 1002 may also include a transmitter 1011 and a receiver 1013 to allow transmission and reception of signals to and from the electronic device 1002 via an antenna 1017. The transmitter 1011 and receiver 1013 may be collectively referred to as a transceiver 1015. As used herein, a “transceiver” is synonymous with a radio. The electronic device 1002 may also include (not shown) multiple transmitters, multiple antennas, multiple receivers and/or multiple transceivers.

The electronic device 1002 may include a digital signal processor (DSP) 1021. The electronic device 1002 may also include a communications interface 1023. The communications interface 1023 may allow a user to interact with the electronic device 1002.

The various components of the electronic device 1002 may be coupled together by one or more buses, which may include a power bus, a control signal bus, a status signal bus, a data bus, etc. For the sake of clarity, the various buses are illustrated in FIG. 10 as a bus system 1019.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise Random-Access Memory (RAM), Read-Only Memory (ROM), Electrically Erasable Programmable Read-Only Memory (EEPROM), flash memory, Compact Disc Read-Only Memory (CD-ROM) or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc, where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

What is claimed is:

1. An electronic device, comprising:
a master integrated circuit (IC) comprising a master finite state machine (FSM);
a slave IC comprising a synchronization module and a slave FSM; and
a control interface coupling the master IC to the slave IC, wherein the control interface is implemented via a single wire;
wherein the master FSM communicates its states or state transitions to the synchronization module via the control interface; and
wherein the synchronization module decodes the master FSM's states or state transitions and uses the decoded states or state transitions to step the slave FSM in real time such that states or state transitions in the slave FSM mirror the states or state transitions in the master FSM.

2. The electronic device of claim 1, wherein the master FSM sends its states or state transitions over the control interface in encoded state bits.

3. The electronic device of claim 1, wherein the master FSM sends an additional bit, in addition to the master FSM's states or state transitions, indicating that other control data will also be sent.

4. The electronic device of claim 3, wherein the other control data comprises at least one of automatic gain control (AGC) data, receive (RX) power control, RX control, transmit (TX) control, TX power control or volume control.

5. The electronic device of claim 1, further comprising a separate register programming interface that is implemented by time multiplexing the single wire of the control interface.

6. The electronic device of claim 1, wherein the states or state transitions communicated by the master FSM comprise a variable series of states or state transitions.

7. The electronic device of claim 1, wherein the slave IC communicates a clock signal to the master IC via a clock interface, wherein the master FSM and the synchronization module of the slave IC synchronize communication of the master FSM's states or state transitions based on the clock signal.

8. The electronic device of claim 1, wherein the master IC communicates a clock signal to the slave IC via a clock interface, wherein the master FSM and the synchronization module of the slave IC synchronize communication of the master FSM's states or state transitions based on the clock signal.

9. The electronic device of claim 1, wherein the control interface is implemented as an asynchronous interface with no clock signal, wherein the slave IC oversamples the control interface to determine a falling edge of a start bit of the master FSM.

10. The electronic device of claim 1, wherein the master IC comprises a digital baseband (BB) IC and the slave IC comprises a radio frequency integrated circuit (RFIC).

11. The electronic device of claim 1, wherein the states or state transitions of the master FSM correspond to equivalent states or state transitions of the slave FSM.

12. The electronic device of claim 1, further comprising a plurality of slave ICs, wherein the master FSM communicates its states or state transitions to each of the plurality of slave ICs, and wherein the plurality of slave ICs use the states or state transitions of the master FSM to step their slave FSMs in real time such that states or state transitions in the plurality of slave FSMs mirror the states or state transitions in the master FSM.

13. A method, comprising:
communicating states or state transitions from a master finite state machine (FSM) of a master integrated circuit (IC) to a synchronization module of a slave IC via a control interface coupling the master IC to the slave IC, wherein the control interface is implemented via a single wire;
decoding, by the synchronization module, the master FSM's states or state transitions; and
stepping a slave FSM of the slave IC in real time based on the decoded states or state transitions such that states or state transitions in the slave FSM mirror the states or state transitions in the master FSM.

14. The method of claim 13, further comprising sending an additional bit from the master FSM, in addition to the master FSM's states or state transitions, the additional bit indicating that other control data will also be sent.

15. The method of claim 14, wherein the other control data comprises at least one of automatic gain control (AGC) data, receive (RX) power control, RX control, transmit (TX) control, TX power control or volume control.

16. The method of claim 13, further comprising time multiplexing a separate register programming interface via the single wire of the control interface.

17. The method of claim 13, wherein the states or state transitions communicated by the master FSM comprise a variable series of states or state transitions.

18. The method of claim 13, further comprising communicating, by the slave IC, a clock signal to the master IC via a clock interface, wherein the master FSM and the synchronization module of the slave IC synchronize communication of the master FSM's states or state transitions based on the clock signal.

19. The method of claim 13, wherein the master IC comprises a digital baseband (BB) IC and the slave IC comprises a radio frequency integrated circuit (RFIC).

20. The method of claim 13, wherein the states or state transitions of the master FSM correspond to equivalent states or state transitions of the slave FSM.

21. An apparatus, comprising:
means for communicating states or state transitions from a master finite state machine (FSM) of a master integrated circuit (IC) to a synchronization module of a slave IC via a control interface coupling the master IC to the slave IC, wherein the control interface is implemented via a single wire;
means for decoding, by the synchronization module, the master FSM's states or state transitions; and
means for stepping a slave FSM of the slave IC in real time based on the decoded states or state transitions such that states or state transitions in the slave FSM mirror the states or state transitions in the master FSM.

22. The apparatus of claim 21, further comprising means for sending an additional bit from the master FSM, in addition to the master FSM's states or state transitions, the additional bit indicating that other control data will also be sent.

23. The apparatus of claim 21, wherein the states or state transitions communicated by the master FSM comprise a variable series of states or state transitions.

24. The apparatus of claim 21, further comprising means for communicating, by the slave IC, a clock signal to the master IC via a clock interface, wherein the master FSM and the synchronization module of the slave IC synchronize communication of the master FSM's states or state transitions based on the clock signal.

25. The apparatus of claim 21, wherein the states or state transitions of the master FSM correspond to equivalent states or state transitions of the slave FSM.

26. A computer-program product, the computer-program product comprising a non-transitory computer-readable medium having instructions thereon, the instructions comprising:
code for causing an electronic device to communicate states or state transitions from a master finite state machine (FSM) of a master integrated circuit (IC) to a synchronization module of a slave IC via a control interface coupling the master IC to the slave IC, wherein the control interface is implemented via a single wire;
code for causing the electronic device to decode, by the synchronization module, the master FSM's states or state transitions; and
code for causing the electronic device to step a slave FSM of the slave IC in real time based on the decoded states or state transitions such that states or state transitions in the slave FSM mirror the states or state transitions in the master FSM.

27. The computer-program product of claim 26, further comprising code for causing the electronic device to send an additional bit from the master FSM, in addition to the master FSM's states or state transitions, the additional bit indicating that other control data will also be sent.

28. The computer-program product of claim 26, wherein the states or state transitions communicated by the master FSM comprise a variable series of states or state transitions.

29. The computer-program product of claim 26, further comprising code for causing the electronic device to communicate, by the slave IC, a clock signal to the master IC via a clock interface, wherein the master FSM and the synchronization module of the slave IC synchronize communication of the master FSM's states or state transitions based on the clock signal.

30. The computer-program product of claim 26, wherein the states or state transitions of the master FSM correspond to equivalent states or state transitions of the slave FSM.
